(19) United States
(12) Patent Application Publication
(10) Pub. No.: US 2023/0222669 A1
(43) Pub. Date: Jul. 13, 2023

(54) Real-time Image Segmentation

(71) Applicant: Meta Platforms Technologies, LLC, Menlo Park, CA (US)

(72) Inventors: Wenliang Zhao, Belmont, CA (US); Peizhao Zhang, Fremont, CA (US); Georgy Marrero, Hollywood, FL (US); Siddharth Sandip Shah, Santa Clara, CA (US); Hyungjun Kim, San Francisco, CA (US)

(21) Appl. No.: 18/152,712

(22) Filed: Jan. 10, 2023

Related U.S. Application Data
(60) Provisional application No. 63/298,150, filed on Jan. 10, 2022.

(51) Int. Cl. G06T 7/12; G06T 7/194

(52) U.S. Cl. CPC G06T 7/12; G06T 7/194; G06T 2207/10016; G06T 2207/20081; G06T 2207/10024; G06T 2207/30196

(57) ABSTRACT

A method includes generating first and second series of segmentation masks for a first and second series of images in a video, respectively. The first series of segmentation masks are generated by using a machine-learning model to (1) generate a first segmentation mask based on a first image in the first series of images and a predetermined fixed segmentation mask, and (2) generate a second segmentation mask based on a second image in the first series of images and the first segmentation mask. The second series of segmentation masks are generated by using the machine-learning model to (1) generate a third segmentation mask based on a third image in the second series of images and the predetermined fixed segmentation mask, and (2) generate a fourth segmentation mask based on a fourth image in the second series of images and the third segmentation mask.

### PRIORITY

This application claims the benefit under 35 U.S.C. § 119(e) of U.S. Provisional Patent Application No. 63/298,150, filed 10 Jan. 2022, which is incorporated herein by reference.

### TECHNICAL FIELD

This disclosure generally relates to computer vision and more particularly to image segmentation tasks.

### BACKGROUND

Image segmentation is a technique for partitioning an image and identify pixels that correspond to particular objects of interest. Image segmentation is useful in a variety of context. For example, video calling applications may use image segmentation to automatically and dynamically distinguish background from foreground so that a virtual background or filters may be applied to hide or obfuscate a user's real-world environment. As another example, augmented or virtual reality applications may use image segmentation to locate objects and apply virtual effects.

The accuracy and consistency of image segmentation techniques may directly affect the quality and user experience of applications. For example, inaccurate segmentation masks used for generating background filters may cause someone's face to be mistakenly filtered or occluded, especially during movements. As another example, inconsistencies in the segmentation masks of a series of images in a video could result in flickering artifacts in the final display. Thus, an improved technique for image segmentation is desired.

### SUMMARY OF PARTICULAR EMBODIMENTS

Embodiments are directed to systems, methods, and media for generating image segmentation masks. A computing system may generate a first series of segmentation masks for a first series of images in a video by: generating, using a machine-learning model, a first segmentation mask based on a first image in the first series of images and a predetermined fixed segmentation mask; and generating, using the machine-learning model, a second segmentation mask based on a second image in the first series of images and the first segmentation mask. The system may generate a second series of segmentation masks for a second series of images in the video by: generating, using the machine-learning model, a third segmentation mask based on a third image in the second series of images and the predetermined fixed segmentation mask; and generating, using the machine-learning model, a fourth segmentation mask based on a fourth image in the second series of images and the third segmentation mask.

In particular embodiments, the computing system may further generate a tensor that includes at least four channels, wherein three of the four channels are generated based on three color channels of the first image, and a fourth channel of the at least four channels is generated based on the predetermined fixed segmentation mask. The first segmentation mask may be generated by using the machine-learning model to process the tensor.

In particular embodiments, at least one channel of the tensor includes (1) an internal portion corresponding to one of the three color channels of the first image and (2) a padding portion surrounding the internal portion, the padding portion being generated using pixels in the internal portion.

In particular embodiments, the padding portion reflects pixels in the internal portion that are within a predetermined depth of pixels from a border of the internal portion, the predetermined depth of pixels having a depth of two or more pixels.

In particular embodiments, a first layer of pixels in the padding portion that are adjacent to border pixels of the internal portion reflect pixels in the internal portion that are adjacent to the border pixels of the internal portion.

In particular embodiments, a first layer of pixels in the padding portion that are adjacent to border pixels of the internal portion reflect the border pixels, and a second layer of pixels in the padding portion that are adjacent to the first layer of pixels reflect pixels in the internal portion that are adjacent to the border pixels of the internal portion.

Particular embodiments for training the machine-learning model may comprise detecting, using a boundary detection algorithm, a first boundary of an object of interest in the first segmentation mask, and detecting, using the boundary detection algorithm, a second boundary of the object of interest in a ground truth segmentation mask associated with the first image. The computing system may determine a set of boundary pixel locations corresponding to the first boundary and the second boundary. The computing system may compare the first segmentation mask to the ground truth segmentation mask, wherein differences at the set of boundary pixel locations are weighted more relative to differences at other pixel locations. The system may update the machine-learning model based on the comparison.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example machine-learning model for generating image segmentation masks, according to particular embodiments.

FIG. 2 illustrates a block diagram of a process for generating image segmentation masks, according to particular embodiments.

FIGS. 3A-3B illustrate examples of a padding portion being added to the border of an input image, according to particular embodiments.

FIG. 4 illustrates a flow diagram for generating image segmentation masks, according to particular embodiments.

FIG. 5 illustrates an example of a computing system for implementing particular embodiments described herein.

### DESCRIPTION OF EXAMPLE EMBODIMENTS

Embodiments described herein improve image segmentation techniques built on Artificial Intelligence (AI) or Machine-Learning (ML) models. An image-segmentation task may be designed to process a given image, which could be an image frame in a video, and determine whether each pixel in the image corresponds to the foreground or background, or to particular objects of interests (e.g., humans, pets, furniture, etc.). In particular embodiments, such determination may take the form of a segmentation mask. A segmentation mask, in particular embodiments, may be implemented as an array (or matrix) of values, where each value is associated with one or more groups of pixels in the input image. For example, an input image with n×m pixels may have a corresponding segmentation mask with n×m values. The value associated with each pixel may indicate a likelihood of that pixel depicting a foreground object(s) or a background object(s). For example, each value may be within a numerical range of 0 to 1, where a larger value represents a higher likelihood of the associated pixel belonging to a foreground object, and a lower value represents a lower likelihood of the associate pixel belong to a foreground object (in other words, a lower value may represent a higher likelihood of the associated pixel belonging to a background object). The resolution of the segmentation mask could be different (i.e., higher or lower resolution) from the input image. For example, each value within the segmentation mask could correspond to a patch of 1 pixel, 2×2 pixels, 3×3 pixels, etc.

A variety of applications may use the segmentation techniques described herein to dynamically and automatically determine whether each pixel in an image depicts the foreground or background, or whether each pixel belongs to one or more object types/instances of interest, etc. For example, in the video calling context, a segmentation mask may indicate which pixels in each image frame of a video stream depicts a person, which may be considered the foreground object. The other non-person pixels may be considered the background. Based on the segmentation mask, the video calling application could apply a filter to the background pixels (e.g., blurring the pixels or preplacing them with a virtual background) while leaving the foreground pixels as-is. The particular features detected by an image-segmentation model depends on the manner in which the model is trained and characteristics of the training data used. In the video calling context, the image-segmentation model may be trained to separate humans from their background. For an application designed to detect pets and provide augmented information (e.g., suggestions for caring for dogs vs. cats), the image-segmentation model may be trained to determine if a given pixel depicts a dog, cat, bird, etc. Image segmentation may also be used in a mixed-reality context, where images of real persons or objects are merged with virtual objects with proper occlusion.

Techniques described herein make any such image-segmentation models more efficient, stable, and versatile, which in turn help enhance the quality and consistency of the segmentation results and the end-user experience. Additional benefits of the present techniques include, but are not limited to, (1) improving boundary smoothness, stability, and general consistency, and (2) allowing image-segmentation models to be efficient and flexible enough to work well on devices with varying levels of capabilities. For the sake of simplicity, the present disclosure will use video calling as an example to illustrate the various techniques, but the present disclosure may be used in other contexts as well.

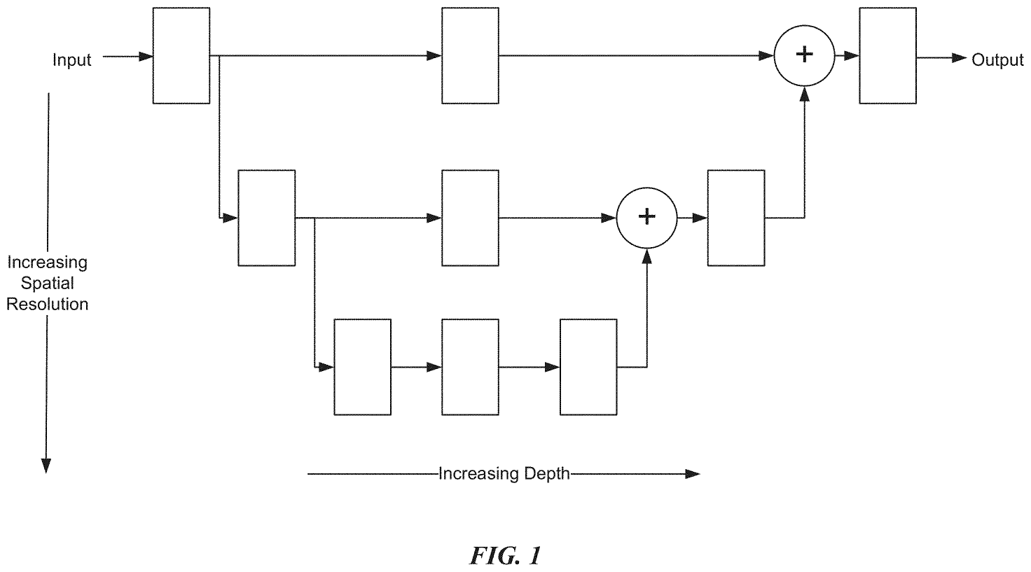

In particular embodiments, an image-segmentation model used for segmenting humans may use an encoder-decoder architecture, with a fusion of layers with the same spatial resolution. Particular embodiments may use a heavy weight encoder with a light decoder, which may achieve better quality than symmetric design architectures. FIG. 1 illustrates an example of an architecture for a semantic segmentation model. The input of the model may be an image with multiple channels. The channels may correspond to a combination of color channels (e.g., Red, Green, and Blue (RGB)), an alpha channel for indicating per-pixel opacity levels, and/or one or more segmentation masks (described in more details below). Each rectangle represents a convolution layer, and each circle represents a concatenation operation. Each convolution block may use a suitable kernel size (e.g., 3×3, 5×5, 7×7, etc.) to slide across the input tensor of that convolution block and perform convolution operations to compute a new tensor for the next layer in the model. Each convolution block includes trainable parameters, which are applied during convolution operations. The trainable parameters are updated/adjusted during model training The end output of the model may be a segmentation mask, as previously described.

Image-segmentation models may be used to generate a series of segmentation masks for a corresponding series of image frames of a video. For example, a computing system (e.g. smartphone, AR/VR headset, computer, etc.) may have an application tasked with generating a series of segmentation masks for a series of images in a video. In the video calling context, the video may be a video stream captured by a camera of the computing system, and the video calling application may be tasked with generating a background filter for the video call before the video is transmitted to another participant to the call. The computing system may use an image-segmentation model to process each image in the video stream to generate a corresponding segmentation mask. It may then use the segmentation mask to identify pixels corresponding to the background (or foreground) and apply a background filter to obfuscate the user's physical environment (e.g., blur or replace the background pixels). The updated video stream may then be transmitted to other participants of the call for display.

Since segmentation masks applied to a video directly affects what is shown to the user, consistency between the masks is important. Temporal inconsistency, which represents frame-to-frame prediction discrepancies, known as flickers, hurts user experience. An image-segmentation model that only considers the information within a given input image, such as its color and/or alpha channels, is generating each segmentation mask in isolation without regard to what was generated before. This lack of temporal awareness could result in flicker and other artifacts in the series of segmentation masks. To improve temporal consistency, particular embodiments use a detect-with-mask process, in which an image-segmentation model not only considers the information within a given input image, but also the mask(s) generated for one or more of the previous frames. For example, rather than configuring the model to only process three color channels (YUV or RGB) from the current image frame, the model is configured to take an additional fourth channel which includes the last segmentation mask generated for the last frame. Conceptually, doing so provides the model with temporal information so that it could strive to generate a segmentation mask for the current frame that is more temporally consistent with the previous mask. In particular embodiments, only a single previous mask is concatenated with the color/alpha channels of the current image frame. In other embodiments, two or more previous masks may be used. For example, if the current image frame is associated with time t, the image-segmentation model may use a predetermined number of n previous segmentation masks (i.e., for frames t-1, t-2, . . . , t-n), along with the current image for frame t, to generate a segmentation mask for the current frame t.

In particular embodiments, all but the first frame in a video may be processed using the method above to improve temporal consistency. For example, if there are n total frames in a video, the aforementioned detect-with-mask process may be used to generate segmentation masks for frames 2 to n. However, for long videos, doing so may not be desirable since any temporal error would be propagated by the detect-with-mask process and exacerbated over time. Thus, in other embodiments, the detect-with-mask process described above may be applied to a limited number of frames before the process refreshes (i.e., by generating a segmentation mask without using any previously-generated masks). For example, each cycle may include k frames. The segmentation mask for Frame 1 may be generated without using a prior segmentation mask, and the segmentation mask for each of Frames 2 to k may be generated using that frame's pixel information and its prior segmentation mask(s). To “refresh” the process, the segmentation mask for Frame k+1 may again be generated without using a prior segmentation mask, and the segmentation masks for Frames k+2 and subsequent frames up to and including Frame 2k may use their respective prior segmentation mask(s). The cycle then repeats until the video stream ends.

In particular embodiments, the above process may be implemented using two image-segmentation models (i.e., two separately trained models). One of the models—referred to as a detect-without-mask model—may generate a segmentation mask based on the current frame's information without considering prior masks (i.e., the model does not consider temporal consistency). Detect-without-mask model would be used during the refresh phase mentioned above. The second model is the aforementioned detect-with-mask model, which generates a segmentation mask based on the current frame's information and its prior masks in order to improve temporal consistency. Two models are used in this embodiment because they are trained to process different inputs—the detect-without-mask model processes the color information of the current image frame (e.g., 3 color channels), whereas the detect-with-mask model processes color information plus at least one prior mask (e.g. 3 color channels+1 mask channel). Having two separate models, however, may not be desirable. The two models would need to be trained separately, and two models would need to be stored on a user's device and loaded into memory at runtime. Especially for resource-constrained devices, the storage and memory requirement could be overly expensive.

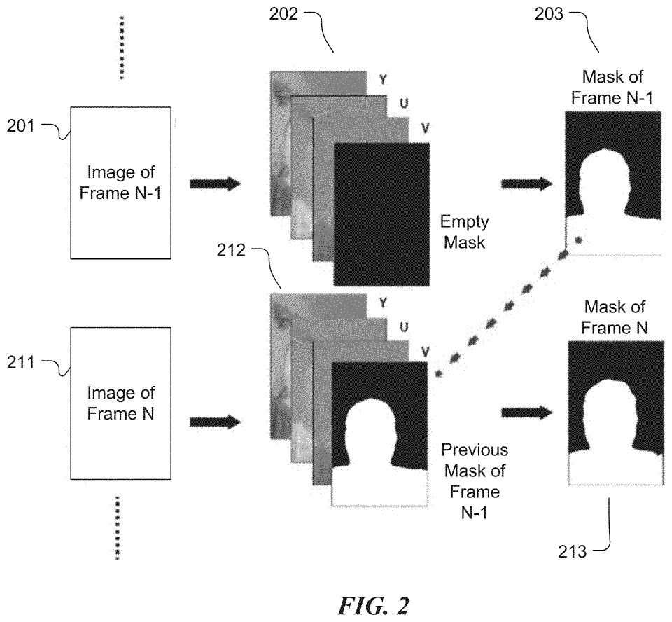

FIG. 2 illustrates an image-segmentation model architecture, according to particular embodiments. This architecture allows a single model to be used for both detect-without-mask and detect-with-mask operations. The model is configured to process a tensor with c+m channels, where c represents the number of channels from the image being processed and m represents the number of prior segmentation masks that could be used. For example, if the input images are expected to have three color channels (c=3) and only a single prior segmentation mask (m=1) is to be used, then the image-segmentation model would be configured to process tensors with four channels. If the input image has an additional alpha channel (c=4) and the model is designed to use the two previous segmentation masks (m=2), then the tensor would have six channels.

For the first frame or any refresh frame where no temporal information is to be used, the m channels may each be a predetermined fixed segmentation mask (e.g., an empty or dummy matrix). For example, each of the m channels (where m is at least 1) may be a matrix of all 0's or all 1's. The “empty” matrix could also be a combination of other values as well. The idea is to use a predetermined fixed segmentation mask that does not change based on the input image. Through training, the image-segmentation model would learn that the particular pattern in the predetermined fixed segmentation mask does not provide any signal regarding the segmentation task at hand and, consequently, could be ignored.

Referring again to FIG. 2, Frame N-1 201 represents an input image for which a segmentation mask is to be generated without regard to prior marks. A tensor 202 with four channels includes the color components (YUV) of the input Frame N-1 201 and an empty mask. An image-segmentation model then processes the tensor 202 to generate a corresponding segmentation mask 203 for Frame N-1 201.

In particular embodiments, the segmentation masks for frames after the first frame or a refresh frame may use the segmentation mask generated for the last frame. In FIG. 2, Frame N 211 is such a frame. The corresponding tensor 212 includes the color channels (YUV) of Frame N 211 plus the segmentation mask 203 generated for the last Frame N-1 201. The same image-segmentation model used to process tensor 202 to generate segmentation mask 203 is used to process tensor 212 to generate segmentation mask 213 for the current Frame N 211. As demonstrated, the architecture shown in FIG. 2 allows a single image-segmentation model to be used to perform segmentation without using the segmentation mask(s) of the last frame(s). The process shown in FIG. 2 may be used during training as well as at runtime, when the model is deployed onto a device and used to perform segmentation tasks.

Another aspect of the present disclosure is aimed at improving border artifacts of the segmentation mask. In particular embodiments, a padding portion may be added around an image received from a source in order to improve accuracy and reduce artifacts in portions of the segmentation masks near the exterior border of the image. Such inaccuracies or artifacts may result due to the nature of a convolutional kernel sliding across the border pixels of the image. For example, a 3×3 kernel performs convolution computations for the pixel at the center of the kernel. When the center pixel is at or near the border of the image, some portions of the kernel would not have any data on which to perform convolution. Adding one or more layers of padding pixels around the image effectively provide supplemental data so that convolutions performed for border pixels would not be performed with missing pixel data.

After a padding portion is added around each channel of a tensor—which could include the color channels of the input image and one or more segmentation masks—each of the resulting channels can be considered as having an internal portion and a padding portion, where the internal portion corresponds to the original input image or segmentation mask.

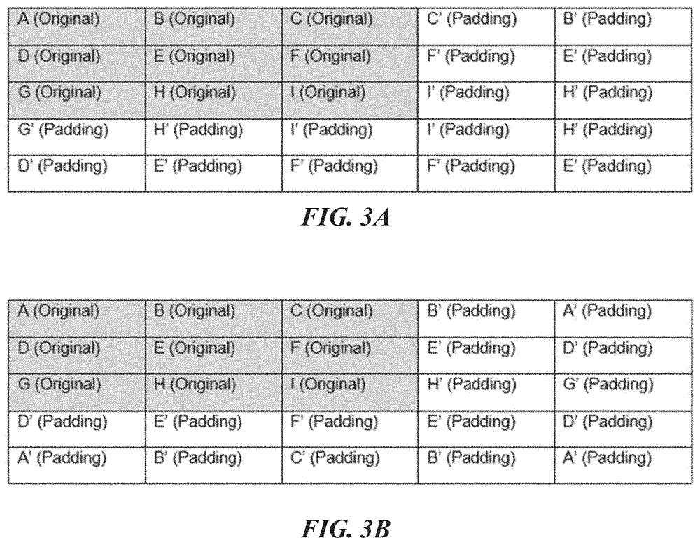

FIGS. 3A and 3B illustrate examples of padding portions being added to a corner of a channel of a tensor. For the sake of simplicity, FIGS. 3A and 3B only show the lower-right corner of the channel. In the illustrated corner, original pixels are labeled A through I, and the padding pixels are labeled A′ through I′. Even though these figures only illustrate a corner of the channel, it should be understood that the padding portion surrounds the original pixels of the input image or segmentation mask.

The pixel depth of the padding portion may depend on the size of the convolutional kernel. For example, for 3×3 convolutional kernels, a padding portion with one pixel depth may be sufficient. For 5×5 convolutional kernels, a padding portion with a depth of two pixels may be used instead. In FIGS. 3A and 3B, a padding portion with a depth of two pixels is shown. For example, in FIG. 3A, padding pixels C′ and B′ are added to the right of the border pixel C, and padding pixels H′ and E′ are added to the bottom of border pixel H. Each pixel depth may also be considered as a layer of pixel. For example, FIGS. 3A and 3B each show two layers of padding pixels.

The padding portion may be gendered based on pixels in the internal portion corresponding to the original image or segmentation mask. The padding portion may be generated using different techniques. In particular embodiments where pixel replication is used (not shown), each pixel in the padding portion may replicate the value of the closest pixel in the internal portion. As an example, a right-most border pixel of an internal portion may have the value C (similar to what is shown in FIGS. 3A and 3B). If three padding pixels are added to the right of that right-most border pixel, the values of those three padding pixels would be CCC. Similarly, if a top-most border pixel in the internal portion has the value A, the three replicated padding pixels added above it would be AAA. While this padding scheme may be sufficient to provide the convolution kernel with supplemental data, the padding may not adequately encode the transitional pixel values near the image border, thus resulting in inaccuracies or artifacts around the borders.

FIG. 3A and FIG. 3B illustrate two embodiments where the padding portion uses a reflection technique to capture the relationship between pixels nearby the border of the internal portion. In general, the padding portion reflects internal pixels near the border of the internal portion, up to a predetermined pixel depth or padding layers. Let's assume, for example, a padding portion with a depth of two pixels is desired. In the embodiment shown in FIG. 3A, the first layer of the padding portion closest to the border of the internal portion copies the border pixel. As shown in FIG. 3A, if a sequence of three pixels at the right border of the internal portion, listed from left to right order, is D-E-F (this is shown in FIG. 3A as the second row of pixels), then the two padding pixels, listed from left to right order, would be F′-E′. Once the padding portion is added to the internal portion, the row of pixels would be D-E-F-F′-E′. Padding pixels could also be added to the other side of the original pixels (not shown for simplicity). Using the same row of pixels as an example, the two padding pixels added to the left of the original pixels D-E-F would be, listed from left to right order, E′-D′. The entire row with padding pixels added to both sides would then be E′-D′-D-E-F-F′-E′. In a similar manner, padding pixels could be added to the top and bottom of the original pixels. For example, if two padding pixels are added to the bottom of the column of original pixels C-F-I (listed from top to bottom), the added pixels would be I′-F′. If two padding pixels are added to the top of the same column of pixels (not shown), the added pixels would be F′-C′. So with padding pixels added to both sides of the column, the column would have pixels F′-C′-C-F-I-I′-F′. The padding pixels in the corner could follow the same reflection technique and reflect the adjacent padding pixels up to the desired depth. In another embodiment, the corner padding pixels could reflect pixels in the same vertical column. In FIG. 3A, the corner padding pixels I′-H′ (the first row of the four corner padding pixels, listed from left to right) is a reflection of the pixels in the same row, which is made up of padding pixels G′-H′-I′. In particular embodiments, the corners could reflect pixels in the same vertical column. In FIG. 3A, the corner padding pixels H′-E′ (the second column of the four corner padding pixels, listed from top to bottom) is a reflection of the pixels in the same column, which is made up of padding pixels B′-E′-H′, listed from top to bottom.

In another embodiment, shown in FIG. 3B, the border pixel of the internal portion is not reflected by the padding portion (i.e., the reflective symmetry is across the border pixels). Looking at the same row of internal pixels D-E-F, the padding portion does not duplicate the internal border pixel (F). As shown in FIG. 3B, the padding pixels added to the right of internal original pixels D-E-F are E′-D′. With the padding pixels, the row becomes D-E-F-E′-D′. Padding pixels could also be added to the other side of the original pixels (not shown for simplicity). Using the same row of pixels as an example, the two padding pixels added to the left of the original pixels D-E-F would be F′-E′. The entire row with padding pixels added to both sides would then be F′-E′-D-E-F-E′-D′. In a similar manner, padding pixels could be added to the top and bottom of the original pixels. For example, if two padding pixels are added to the bottom of the column of original pixels C-F-I (listed from top to bottom), the added pixels would be F′-C′. If two padding pixels are added to the top of the same column of pixels (not shown), the added pixels would be I′-F′. So with padding pixels added to both sides of the column, the column would have pixels I′-F′-C-F-I-F′-C′. The padding pixels in the corner could follow the same reflection technique and reflect the adjacent padding pixels up to the desired depth. In particular embodiments, the corners could reflect pixels in the same horizonal row. For example, in FIG. 3B, the corner padding pixels E′-D′ (the first row of the four corner padding pixels, listed from left to right) is a reflection of the pixels in the same row, which is made up of padding pixels D′-E′-F′. In another embodiment, the corner padding pixels could reflect pixels in the same vertical column. For example, in FIG. 3B, the corner padding pixels D′-A′ (the second column of the four corner padding pixels, listed from top to bottom) is a reflection of the pixels in the same column, which is made up of padding pixels A′-D′-G′.

The reflection padding technique helps preserve the pixel transition information at the border, thereby improving the performance of the segmentation mask model.

The padding techniques may be integrated with the overall architecture descried herein. For example, referring again to FIG. 2, the padding process may be injected as part of the process of generating tensors 202, 212. For example, each of the YUV channels of tensor 212 may be generated using the YUV channels extracted from Frame 211 plus an added padding portion Similarly, the mask channel of tensor 212 may be generated using the last mask 203 plus an added padding portion.

Another aspect of the present disclosure is directed to improving the boundary of the segmented object (e.g., person). Creating smooth and clear boundaries is important for applications that utilize segmentation. The conventional cross-entropy loss used for training an image segmentation model treats all pixels equally. For example, trimap weighted loss function may be used to improve a model's quality. However, one limitation of the trimap loss function is that it calculates the boundary region based on the ground truth only without considering the boundary in the predicted segmentation mask. Therefore, it is an asymmetric loss insensitive to false positives.

Particular embodiments provide an improved loss function that takes into account the boundary regions in both the ground truth and the predicted segmentation mask. Any suitable boundary detection algorithm—such as Boundary IoU or other methods—may be used to detect the boundary regions in the ground truth segmentation mask and the predicted segmentation mask. Pixels in the detected boundary regions may be given more weight by the loss function. For example, the cross-entropy loss may be defined as: w*(−(y log(p)+(1−y)log(1−p))), where w=1.0 for a pixel that is in the detected boundary regions, and w=c (e.g., c is a constant, which could be set to 0.1 by default) for pixels outside of the detected boundary regions. The loss function measures how close the generated segmentation mask is to a known target ground truth associated with that training sample. The loss is backpropagated to update the model so that the model would perform better in the next training iteration. The image-segmentation model trained on boundary cross entropy outperforms conventional methods significantly. Besides making the boundary area clearer in the final mask output, false positives from the new models occur less frequently.

An example process for training an image-segmentation model according to the present disclosures would now be described. Each training sample in the training data set may include an input image (e.g., an image in a video) and an associated ground truth segmentation mask (i.e., the desired/target segmentation mask that the model would learn to generate). During one training iteration, the color and/or alpha components of the input image and either an empty or prior segmentation mask(s) may be combined to generate a tensor. In particular embodiments, a padding portion may be added to each channel of the tensor according to the methods described herein. The image-segmentation model may process the tensor using its current model parameters/weights to generate a predicted output segmentation mask for the input image. The predicted segmentation mask and the ground truth segmentation mask are compared using a loss function, and the computed loss is backpropagated and used to update the model parameters/weights. In particular embodiments, the loss function could give more weight to the boundaries of the segmented objects of interest (e.g., the boundaries of detected humans or other foreground objects). A boundary detection algorithm may be used to detect boundary pixels in the boundary regions in the predicted segmentation mask and the ground truth segmentation mask. The boundary loss function would give more weight to boundary pixels inside the boundary regions than non-boundary pixels outside of the boundary regions. Such training iterations may repeat until a terminating condition is met (e.g., the accuracy of the predictions achieve a threshold level or the training data set is exhausted).

Once trained, the image-segmentation model may be deployed onto any device. For example, a model trained to detect humans may be installed with a video calling application. Each image frame captured by the user may be processed by the image-segmentation model to generate a corresponding segmentation mask. In particular embodiments, the image may be combined with an empty segmentation mask or a prior segmentation mask to generate a tensor. In particular embodiments, a padding portion may be added to each channel of the tensor. The segmentation mask generated by the image-segmentation model may be used by the video calling application to identify background pixels. Depending on the user's preference, the video calling application could blur or replace those background pixels in the input image. The modified input image may then be transmitted to another device for display.

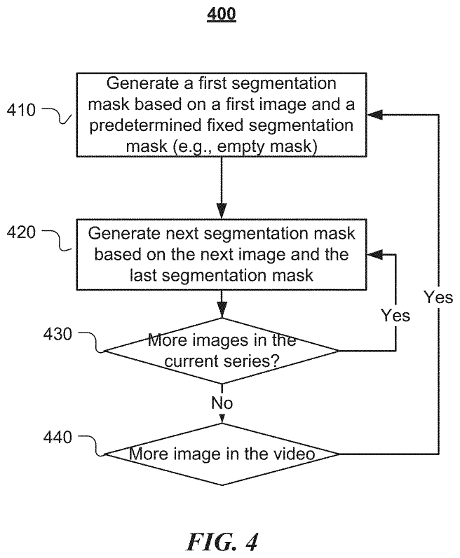

FIG. 4 illustrates an example method 400 for performing image segmentations for images in a video, according to particular embodiments. A computing system may use method 400 to generate a first series of segmentation masks for a first series of images in a video. At step 410, the computing system may generate, using a machine-learning model, a first segmentation mask based on a first image in the first series of images and a predetermined fixed segmentation mask (e.g., an empty mask). At step 420, the computing system may generate, using the machine-learning model, a second segmentation mask based on a second image in the first series of images and the first segmentation mask. This process may continue until a segmentation mask is generated for each remaining image in the first series of images. For example, at step 430, if there are more images in the series (e.g., a threshold number of segmentation masks has not yet been completed), then the computing system may repeat Step 420. For example, the computing system may generate, using the machine-learning model, a next segmentation mask based on the next image in the first series of images and the second segmentation mask generated in the previous iteration. On the other hand, when there are no more images in the series for which to generate segmentation masks, the computing system may determine, at step 440, whether there are additional images in the video for which to generate segmentation masks. If there are additional images, the computing system may refresh the aforementioned process to generate a second series of segmentation masks for a second series of images in the video. At step 410, the system may generate, using the machine-learning model, a third segmentation mask based on a third image in the second series of images and the predetermined fixed segmentation mask (i.e., no temporal information is being used). Then at step 420, the system may generate, using the machine-learning model, a fourth segmentation mask based on a fourth image in the second series of images and the third segmentation mask. This process may repeat until the end of the video or when the feature is turned off (e.g., when the user decides to not apply background filters to the video).

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for generating segmentation masks including the particular steps of the method of FIG. 4, this disclosure contemplates any suitable method for generating segmentation masks including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

In particular embodiments, the image segmentation feature described herein may be subject to a privacy setting associated with the video stream and/or objected depicted therein. The privacy settings (or “access settings”) for an object may be stored in any suitable manner, such as, for example, in association with the object, in an index on an authorization server, in another suitable manner, or any combination thereof. A privacy setting of an object may specify how the video or object (or particular information associated with an object) can be accessed (e.g., viewed or shared). In particular embodiments, an application using the image segmentation feature may access and process a video only if the user explicitly grant the application permission to do so.

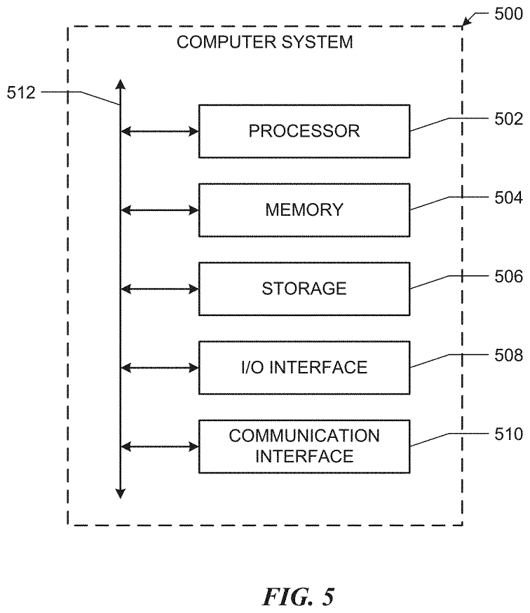

FIG. 5 illustrates an example computer system 500 which may be used to perform image segmentation. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
generating a first series of segmentation masks for a first series of images in a video by:
generating, using a machine-learning model, a first segmentation mask based on a first image in the first series of images and a predetermined fixed segmentation mask; and
generating, using the machine-learning model, a second segmentation mask based on a second image in the first series of images and the first segmentation mask; and
generating a second series of segmentation masks for a second series of images in the video by:
generating, using the machine-learning model, a third segmentation mask based on a third image in the second series of images and the predetermined fixed segmentation mask; and
generating, using the machine-learning model, a fourth segmentation mask based on a fourth image in the second series of images and the third segmentation mask.

2. The method of claim 1, further comprising:
generating a tensor that includes at least four channels, wherein three of the four channels are generated based on three color channels of the first image, and a fourth channel of the at least four channels is generated based on the predetermined fixed segmentation mask;
wherein the first segmentation mask is generated by using the machine-learning model to process the tensor.

3. The method of claim 2, wherein at least one channel of the tensor includes (1) an internal portion corresponding to one of the three color channels of the first image and (2) a padding portion surrounding the internal portion, the padding portion being generated using pixels in the internal portion.

4. The method of claim 3, wherein the padding portion reflects pixels in the internal portion that are within a predetermined depth of pixels from a border of the internal portion, the predetermined depth of pixels having a depth of two or more pixels.

5. The method of claim 4, wherein a first layer of pixels in the padding portion that are adjacent to border pixels of the internal portion reflect pixels in the internal portion that are adjacent to the border pixels of the internal portion.

6. The method of claim 4, wherein a first layer of pixels in the padding portion that are adjacent to border pixels of the internal portion reflect the border pixels, and a second layer of pixels in the padding portion that are adjacent to the first layer of pixels reflect pixels in the internal portion that are adjacent to the border pixels of the internal portion.

7. The method of claim 1, wherein the method is used for training the machine-learning model, the method further comprising:
detecting, using a boundary detection algorithm, a first boundary of an object of interest in the first segmentation mask;
detecting, using the boundary detection algorithm, a second boundary of the object of interest in a ground truth segmentation mask associated with the first image;
determining a set of boundary pixel locations corresponding to the first boundary and the second boundary;
comparing the first segmentation mask to the ground truth segmentation mask, wherein differences at the set of boundary pixel locations are weighted more relative to differences at other pixel locations; and
updating the machine-learning model based on the comparison.

8. A system comprising:
one or more processors; and
one or more computer-readable non-transitory storage media coupled to one or more of the processors and comprising instructions operable when executed by one or more of the processors to cause the system to:
generate a first series of segmentation masks for a first series of images in a video by:
generating, using a machine-learning model, a first segmentation mask based on a first image in the first series of images and a predetermined fixed segmentation mask; and
generating, using the machine-learning model, a second segmentation mask based on a second image in the first series of images and the first segmentation mask; and
generate a second series of segmentation masks for a second series of images in the video by:
generating, using the machine-learning model, a third segmentation mask based on a third image in the second series of images and the predetermined fixed segmentation mask; and
generating, using the machine-learning model, a fourth segmentation mask based on a fourth image in the second series of images and the third segmentation mask.

9. The system of claim 8, wherein the processors are further operable when executing the instructions to:
generate a tensor that includes at least four channels, wherein three of the four channels are generated based on three color channels of the first image, and a fourth channel of the at least four channels is generated based on the predetermined fixed segmentation mask;
wherein the first segmentation mask is generated by using the machine-learning model to process the tensor.

10. The system of claim 9, wherein at least one channel of the tensor includes (1) an internal portion corresponding to one of the three color channels of the first image and (2) a padding portion surrounding the internal portion, the padding portion being generated using pixels in the internal portion.

11. The system of claim 10, wherein the padding portion reflects pixels in the internal portion that are within a predetermined depth of pixels from a border of the internal portion, the predetermined depth of pixels having a depth of two or more pixels.

12. The system of claim 11, wherein a first layer of pixels in the padding portion that are adjacent to border pixels of the internal portion reflect pixels in the internal portion that are adjacent to the border pixels of the internal portion.

13. The system of claim 11, wherein a first layer of pixels in the padding portion that are adjacent to border pixels of the internal portion reflect the border pixels, and a second layer of pixels in the padding portion that are adjacent to the first layer of pixels reflect pixels in the internal portion that are adjacent to the border pixels of the internal portion.

14. The system of claim 8, wherein the processors are further operable when executing the instructions to:
detect, using a boundary detection algorithm, a first boundary of an object of interest in the first segmentation mask;
detect, using the boundary detection algorithm, a second boundary of the object of interest in a ground truth segmentation mask associated with the first image;
determine a set of boundary pixel locations corresponding to the first boundary and the second boundary;
compare the first segmentation mask to the ground truth segmentation mask, wherein differences at the set of boundary pixel locations are weighted more relative to differences at other pixel locations; and
update the machine-learning model based on the comparison.

15. One or more computer-readable non-transitory storage media embodying software that is operable when executed to:
generate a first series of segmentation masks for a first series of images in a video by:
generating, using a machine-learning model, a first segmentation mask based on a first image in the first series of images and a predetermined fixed segmentation mask; and
generating, using the machine-learning model, a second segmentation mask based on a second image in the first series of images and the first segmentation mask; and
generate a second series of segmentation masks for a second series of images in the video by:
generating, using the machine-learning model, a third segmentation mask based on a third image in the second series of images and the predetermined fixed segmentation mask; and
generating, using the machine-learning model, a fourth segmentation mask based on a fourth image in the second series of images and the third segmentation mask.

16. The media of claim 15, wherein the software is further operable when executed to:
generate a tensor that includes at least four channels, wherein three of the four channels are generated based on three color channels of the first image, and a fourth channel of the at least four channels is generated based on the predetermined fixed segmentation mask;
wherein the first segmentation mask is generated by using the machine-learning model to process the tensor.

17. The media of claim 16, wherein at least one channel of the tensor includes (1) an internal portion corresponding to one of the three color channels of the first image and (2) a padding portion surrounding the internal portion, the padding portion being generated using pixels in the internal portion.

18. The media of claim 17, wherein the padding portion reflects pixels in the internal portion that are within a predetermined depth of pixels from a border of the internal portion, the predetermined depth of pixels having a depth of two or more pixels.

19. The media of claim 18, wherein a first layer of pixels in the padding portion that are adjacent to border pixels of the internal portion reflect the border pixels, and a second layer of pixels in the padding portion that are adjacent to the first layer of pixels reflect pixels in the internal portion that are adjacent to the border pixels of the internal portion.

20. The media of claim 15, wherein the software is further operable when executed to:
detect, using a boundary detection algorithm, a first boundary of an object of interest in the first segmentation mask;
detect, using the boundary detection algorithm, a second boundary of the object of interest in a ground truth segmentation mask associated with the first image;
determine a set of boundary pixel locations corresponding to the first boundary and the second boundary;
compare the first segmentation mask to the ground truth segmentation mask, wherein differences at the set of boundary pixel locations are weighted more relative to differences at other pixel locations; and
update the machine-learning model based on the comparison.
